(19) United States
(12) Patent Application Publication
(10) Pub. No.: US 2016/0370633 A1
(43) Pub. Date: Dec. 22, 2016

(54) CURVED DISPLAY DEVICE

(71) Applicant: Samsung Display Co., Ltd., Yongin-City (KR)

(72) Inventors: Hyungsup BYEON, Seoul (KR); SUNG HOON KIM, Seoul (KR); Dongkun KIM, Daejeon (KR); EUNJU KIM, Suwon-si (KR); Seung-Ho BAEK, Cheonan-si (KR); JiWon SOHN, Seoul (KR)

(21) Appl. No.: 15/252,445

(22) Filed: Aug. 31, 2016

Related U.S. Application Data
(62) Division of application No. 13/905,372, filed on May 30, 2013.

(30) Foreign Application Priority Data
Sep. 28, 2012 (KR) 10-2012-0108835

(51) Int. Cl. G02F 1/1339; G02F 1/1335

(52) U.S. Cl. CPC G02F 1/13394; G02F 1/133514; G02F 1/133512; G02F 2001/13396

(57) ABSTRACT

A display device includes a curved first substrate; a second substrate facing the first substrate; an image display layer which displays an image, the image display layer between the first substrate and the second substrate; and a plurality of spacers which maintains a space between the first and second substrates, the spacers being between the first substrate and the second substrate. Heights of the spacers decrease from a center portion of the display device toward an end portion of the display device.

This application is a divisional application of U.S. patent application Ser. No. 13/905,372 filed on May 30, 2013, which claims priority to Korean Patent Application No. 10-2012-0108835, filed on Sep. 28, 2012, and all the benefits accruing therefrom under 35 U.S.C. §119, the entire contents of which are hereby incorporated by reference in their entirety.

### BACKGROUND

(1) Field

The invention described herein relates to display devices, and more particularly, to a curved display device.

(2) Description of the Related Art

A flat display device such as a liquid crystal display (“LCD”) or a plasma discharge panel (“PDP”) has a high definition characteristic, an ultra-thin characteristic, a light-weight characteristic and a wide viewing angle characteristic.

When a flat display device is installed in an open space like an outdoor square or an indoor square like an airport and a terminal thereof, an image being displayed can be clearly seen to people within a predetermined viewing angle of the flat display panel. However, when a flat display device is installed in an open space like an outdoor square or an indoor square like an airport and a terminal thereof, an image being displayed cannot be clearly seen to people outside a predetermined viewing angle of the flat display panel, for instance, people on the left side, the right side and the back side of the flat display device.

Accordingly, display devices that can be seen to a user from various directions are being developed and one of them is a curved display device.

### SUMMARY

Exemplary embodiments of the invention provide a display device.

The display device includes a curved first substrate; a second substrate facing the first substrate; an image display layer between the first substrate and the second substrate, which displays an image; and a plurality of spacers between the first substrate and the second substrate, which maintains a gap between the first and second substrates. Heights of the spacers decrease from a center portion of the display device toward an end portion of the display device.

In an exemplary embodiment of the invention, the display device may include color filters on the second substrate, which provide color to the image display layer, and a black matrix between the color filters. In a portion of the spacers, each spacer includes a color portion including the black matrix or a color filter, and a support portion on the color portion. The color filters include a red color filter, a green color filter, and a blue color filter. The spacer may include more than one color filter which are sequentially stacked.

In an exemplary embodiment of the invention, a thickness of the center portion is different from that of the end portion, in at least one of the first and second substrates.

### BRIEF DESCRIPTION OF THE DRAWINGS

The above and other features of this disclosure will become more apparent by describing in further detail exemplary embodiments thereof with reference to the accompanying drawings in which:

FIG. 1 is a perspective view illustrating an exemplary embodiment of a display device in accordance with the invention.

FIG. 2 is a top plan view of the display device illustrated in FIG. 1 when the display device of FIG. 1 is provided to have a flat surface.

FIG. 3 is a cross-sectional view taken along line I-I′ of FIG. 2.

FIGS. 4A and 4B are cross-sectional views of a conventional display device and an exemplary embodiment of a display device in accordance with the invention.

FIG. 5 is a graph representing transmittance of light according to a cell gap in micrometers (μm) in a liquid crystal display (“LCD”) device.

FIG. 6 is a cross-sectional view of another exemplary embodiment of a display device in accordance with the invention.

FIG. 7 is a cross-sectional view of another exemplary embodiment of a display device in accordance with the invention.

FIG. 8 is a cross-sectional view of another exemplary embodiment of a display device in accordance with the invention.

FIG. 9 is a cross-sectional view of another exemplary embodiment of a display device in accordance with the invention.

FIG. 10 is a cross-sectional view of another exemplary embodiment of a display device in accordance with the invention.

FIG. 11 is a cross-sectional view of another exemplary embodiment of a display device in accordance with the invention.

### DETAILED DESCRIPTION

Exemplary embodiments of the invention will be described below in more detail with reference to the accompanying drawings. The invention may, however, be embodied in different forms and should not be constructed as limited to the exemplary embodiments set forth herein. Rather, these exemplary embodiments are provided so that this disclosure will be thorough and complete, and will fully convey the scope of the invention to those skilled in the art. Like numbers refer to like elements throughout.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, connected may refer to elements being physically and/or electrically connected to each other. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “under” relative to other elements or features would then be oriented “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings

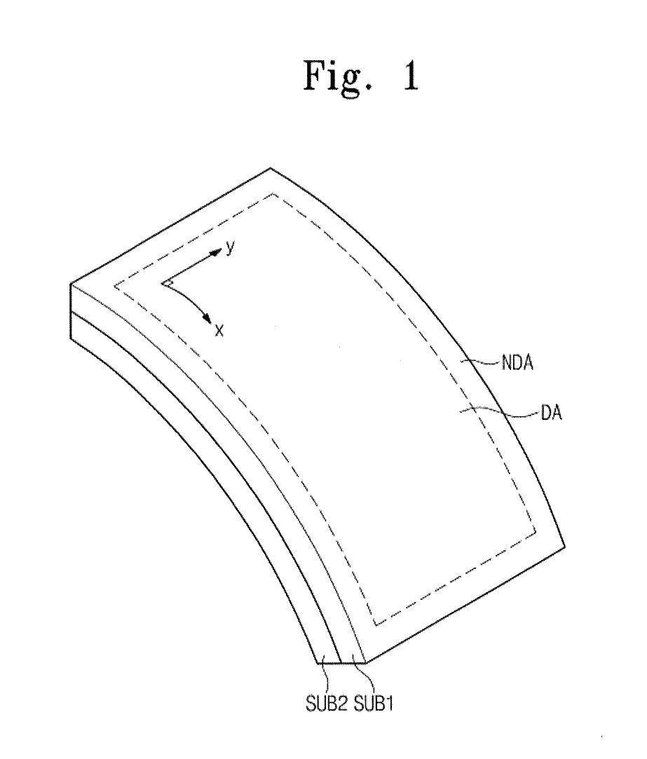

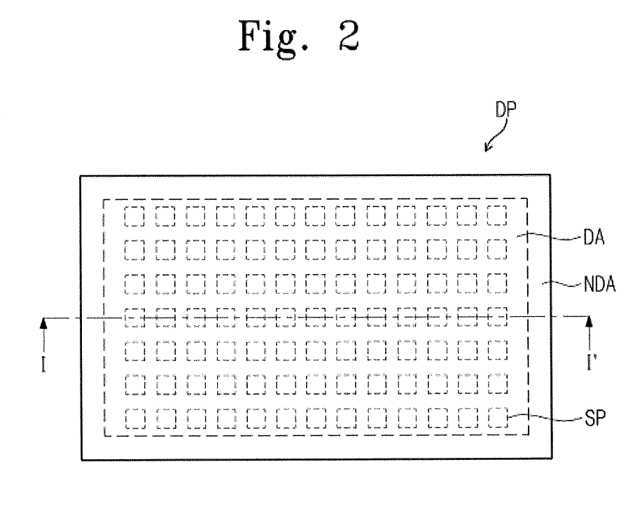

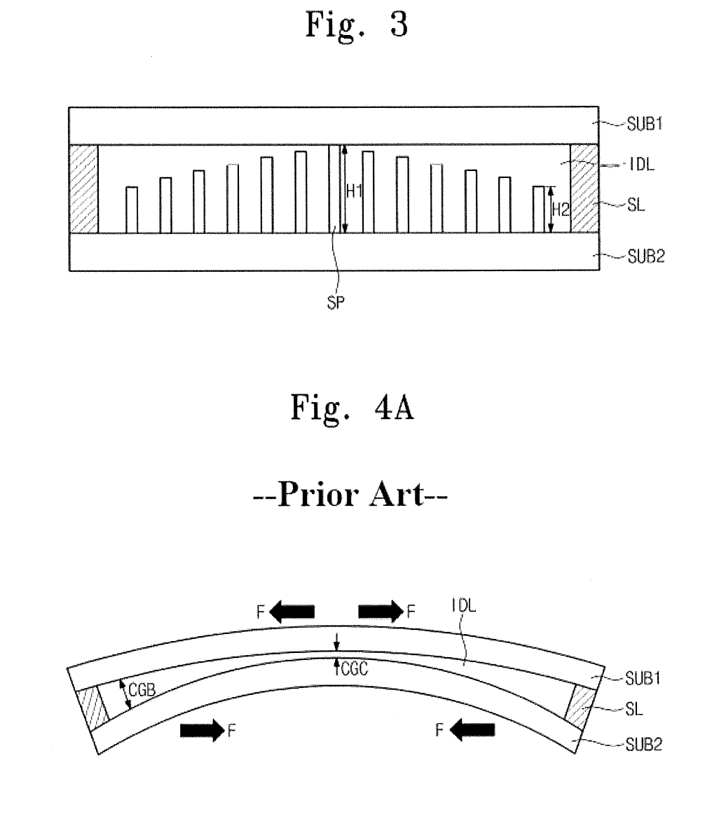

FIG. 1 is a perspective view illustrating an exemplary embodiment of a display device in accordance with the invention. FIG. 2 is a top plan view of the display device illustrated in FIG. 1 when the display device of FIG. 1 is provided to have a flat surface. FIG. 3 is a cross-sectional view taken along line I-I′ of FIG. 2.

The display device DP in accordance with the invention displays an image. The display device includes a display area DA in which the image is displayed, and a non-display area NDA which is provided to at least one side of the display area DA and in which an image is not displayed. Examples of the display device include, but are not limited to, a liquid crystal display panel, an electrowetting display panel, an electrophoretic display panel, etc. In the illustrated exemplary embodiment, a liquid crystal display panel is described as an illustration.

The display device may be provided with a substantially rectangular plate shape, having two pairs of parallel sides. Any one pair of the parallel sides may be longer than the other pair of parallel sides. In the illustrated exemplary embodiment, the display device has a substantially rectangular shape having a pair of long sides and a pair of short sides. An extending direction of the long sides, in which the long sides are elongated, is indicated as an x-axis direction and an extending direction of the short sides, in which the short sides are elongated, is indicated as a y-axis direction.

The display device may have flexibility. An original shape of the display device may be flat or curved, and a final shape of the display device may be different from the original shape of the display device. The display device may be curved to various shapes and/or curve profiles. In one exemplary embodiment, for example, in the display device, if a direction in which an image is displayed is referred to as an upper direction, and a direction opposite to the upper direction is referred to as a lower direction, the display device may be convexly curved in the upper direction or the lower direction. However, a curved direction of the display device is not limited thereto.

Although an initial shape of the display device may be provided to be a curved shape, the display device may be hard without flexibility (e.g., inflexible or static). In one exemplary embodiment, for instance, the display device may be provided to be fixed in a shape where the display device is convexly curved in the lower direction or the upper direction, a center of the display device is convexly curved in the upper direction, that is, toward a user, or one part of the display device is convexly curved in the upper direction and the other part of the display device is convexly curved in the lower direction.

In exemplary embodiments of the invention, a shape where the display device is curved along the extending direction of the long sides, that is, the x-axis direction is described as an illustration, but the invention is not limited thereto. A shape where the display device is convexly curved in the upper direction so that a cross-section of the final shape of the display device has a predetermined curvature when the cross-section of the display device is taken in the x-axis direction described as an illustration, but the invention is not limited thereto. As used herein, the “curvature” means a curvature of a cross-section of a flat surface taken in a direction perpendicular to the flat surface, along a curved direction of the flat surface.

In alternative exemplary embodiments of the invention, the shape where the display device is curved in the y-axis direction may be provided, and in other exemplary embodiments of the invention, the shape that the display device is curved in the x-axis direction and the y-axis direction at the same time may be provided. In still other exemplary embodiments of the invention, the display device may be curved with respect to a direction which is not the x-axis and the y-axis.

The display device includes a first substrate SUB1, a second substrate SUB2 facing the first substrate SUB1, a liquid crystal layer as an image display layer IDL which is provided between the first substrate SUB1 and the second substrate SUB2 to display an image, and a plurality of spacers SP which is provided between the first substrate SUB1 and the second substrate SUB2 to maintain a gap between the first substrate SUB1 and the second substrate SUB2.

A sealant SL may be provided between the first substrate SUB1 and the second substrate SUB2. The sealant SL is provided to have a closed curve shape along an end portion of the first substrate SUB1 or the second substrate SUB2, such as in the plan view.

According to an exemplary embodiment of the invention, the first substrate SUB1 may include a plurality of pixel electrodes (not shown) and a plurality of thin film transistors (not shown) electrically connected to the pixel electrodes respectively. Each thin film transistor is switched to apply a drive signal to a corresponding pixel electrode. The second substrate SUB2 may include a common electrode (not shown) to form an electric field together with the pixel electrodes for controlling an arrangement of liquid crystal in the liquid crystal layer. According to an alternative exemplary embodiment of the invention, the second substrate SUB2 may include a plurality of pixel electrodes and thin film transistors, and the first substrate SUB1 may include a common electrode.

The first substrate SUB1 is provided with a curved shape. That is, the first substrate SUB1 is curved in the x-axis direction and taken along the first substrate SUB1 in the x-axis direction, a cross-section of final shape of the first substrate SUB1 has a predetermined curvature. The second substrate SUB2 is disposed to face the first substrate SUB1 and is spaced apart from the first substrate SUB1. The second substrate SUB2 is curved in the x-axis direction and has the same curvature as the first substrate SUB1. A separation distance (e.g., a cell gap) between the first and second substrates SUB1 and SUB2 has substantially the same value regardless of the location along the first and second substrates SUB1 and SUB2.

The spacers SP may be provided on only one of the first substrate SUB1 and the second substrate SUB2 or may be provided on both the first substrate SUB1 and the second substrate SUB2. The spacers SP may not overlap each other when coupling of the first substrate SUB1 and the second substrate SUB2. In the illustrated embodiment, the spacers SP are provided on the second substrate SUB2. Although the spacers SP are illustrated to have cross-sections of a rectangular shape, the invention is not limited thereto. The spacers SP may have cross-section of different shapes such as a trapezoidal shape. In an exemplary embodiment of a method of manufacturing the display device, the spacers may have different cross-sectional shapes by changing a condition of photholithography process used in forming (e.g., providing) the spacers.

A height of a spacer SP is taken perpendicular to the first and/or second substrate SUB1 and SUB2, that is, in a cross-sectional direction. Referring to FIG. 3, for example, heights of the plurality of spacers SP become smaller sequentially as approaching an end portion of the second substrate SUB2 from the center of the second substrate SUB2. The end portion means an end of a substrate in the curved direction. In the illustrated embodiment, the end portion means both of opposing ends of the substrate taken in the x-axis direction, when the display device is curved in the x-axis direction. The center portion is an area between the opposing ends and refers to an area or a point including a center of a length of the display device in the x-axis direction. In alternative exemplary embodiments, if a curved direction of the first substrate SUB1 is different than the illustrated x-direction, the center and the end portion are similarly defined along the curved direction.

If a height of spacer SP located at an area corresponding to the center portion of the x-axis direction is referred to as a first height H1 and a height of spacer SP located closer to the end portion than the spacer SP located at the center portion is referred to as a second height H2, the first height H1 is greater than the second height H2. An amount of change in the height of the spacers SP may be uniform over an entire area of the second substrate SUB2. However, the invention is not limited thereto, for example, the amount of change in height of the spacers SP may be different (e.g., non-uniform) depending on a position or an area of the second substrate SUB2.

In an exemplary embodiment of a method of manufacturing the display device, the spacers SP may be formed by using a photoresist. The photoresist may be a photosensitive polymer and a material thereof is not particularly limited. In one exemplary embodiment, for example, the photoresist includes a material which undergoes a photopolymerization or photodecomposition. The spacer SP may be formed by a patterning process applied to the photoresist through a photolithography process.

In one exemplary embodiment of a method of manufacturing the display device, the photolithography process is performed as follows.

A photoresist solution is coated on the second substrate SUB2. The photoresist solution may be pre-baked so that a portion of solvent within the photoresist is volatilized.

Using a mask, an exposure process in which light such as ultraviolet light is irradiated onto the photoresist solution or the pre-baked photoresist solution, is performed. The mask has a pattern corresponding to a dimension and/or position of the spacers. The mask may be a slit mask or a halftone mask so that a height of the spacers can be controlled. If the photoresist is a negative type, spacers at a position in which a relatively large amount of light is exposed may be formed with a comparatively large height. A pattern of a penetration part or a shading part of the mask may be provided in various forms so that the density (e.g., the number of spacers/unit area of the substrate) or/and an area (e.g., a planar area) of the spacers is controlled.

The photoresist is developed. Through the development process, the spacers are formed by patterning the exposed portion or the un-exposed portion of the photoresist solution.

In the display device having the structure described above, a gap between the first substrate SUB1 and the second substrate SUB2, that is, a cell gap, is substantially uniformly maintained over an entire area of the first substrate SUB1 and/or the second substrate SUB2.

FIGS. 4A and 4B are cross-sectional views of a conventional display device and an exemplary embodiment of a display device in accordance with the invention. For convenience of description, FIGS. 4A and 4B are cross-sections illustrating only the first substrate SUB1, the second substrate SUB2 and the sealing material, and excluding the spacer SP. The conventional display device has substantially the same structure as the exemplary embodiment of the display device in accordance with the invention, except for a configuration of the spacers SP. That all the spacers in the conventional display device have a same height in contrast to the exemplary embodiment of the display device in accordance with the invention.

Referring to FIG. 4A, in the conventional display device including the spacers having the same height, when the display device is curved, the second substrate SUB2 receives a force F in a center portion direction and the first substrate SUB1 receives a force F in an end portion direction. However, since a compression characteristic of substrates used in the display device is not good, a curvature difference occurs between the center portion and the end portion of the substrate located in the curved direction. If a curvature of the first substrate SUB1 is referred to a first curvature and a curvature of the second substrate SUB2 is referred to as a second curvature, the second curvature is greater than the first curvature. As a result, in the conventional display device including the spacers having the same height, the cell gap CGC of the center portion becomes smaller than the cell gap CGC of the end portion in a normal direction to the first and second substrates SUB1 and SUB2.

Referring to FIG. 4B, in the exemplary embodiment of the display device in accordance with the invention including the spacers having different heights, even where the display device is curved, the cell gap over an entire area of the display device is uniformly maintained. This is because spacers SP corresponding to the center portion have a height greater than a height of spacers SP located at the end portion, thereby maintaining the cell gap between the first substrate SUB1 and the second substrate SUB2 so that the cell gap of the center portion is not reduced. Accordingly, in the exemplary embodiment of the display device including the spacers having different heights in accordance with the invention, the cell gap CGC of the center portion and the cell gap CGB of the end portion remain the same even when the display device is curved, such as from an original position or curvature. Also, a curvature of the first substrate SUB1 and a curvature of the second substrate SUB2 are substantially the same, even when the display device is curved, such as from an original position or curvature.

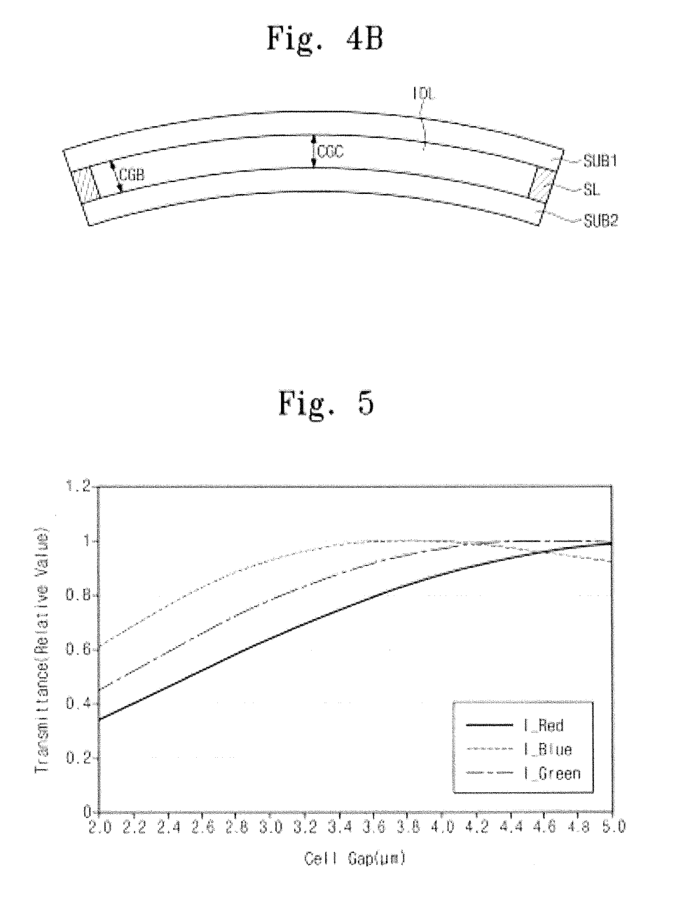

FIG. 5 is a graph representing transmittance of light according to a cell gap in micrometers (μm) in a liquid crystal display (“LCD”) device. Referring to FIG. 5, as the cell gap becomes greater, an increase of brightness of a blue light (I_Blue) is small while an increase of brightness of a green light (I_Green) and a red light (I_Red) is relatively large. Thus, as the cell gap becomes greater, a color coordinate value moves to an opposite side of a blue color and thereby an image may become yellowish.

Thus, in the conventional display device of FIG. 4A, in where the cell gap of the end portion is greater than the cell gap of the center portion, a yellowish phenomenon may occur in an image displayed at the end portion. As a result, image quality of the conventional display device decreases. In comparison, in one or more exemplary embodiment of the invention, where the cell gap of the center portion and the cell gap of the end portion are the same, a yellowish phenomenon does not occur and a yellowish defect may be reduced or effectively prevented.

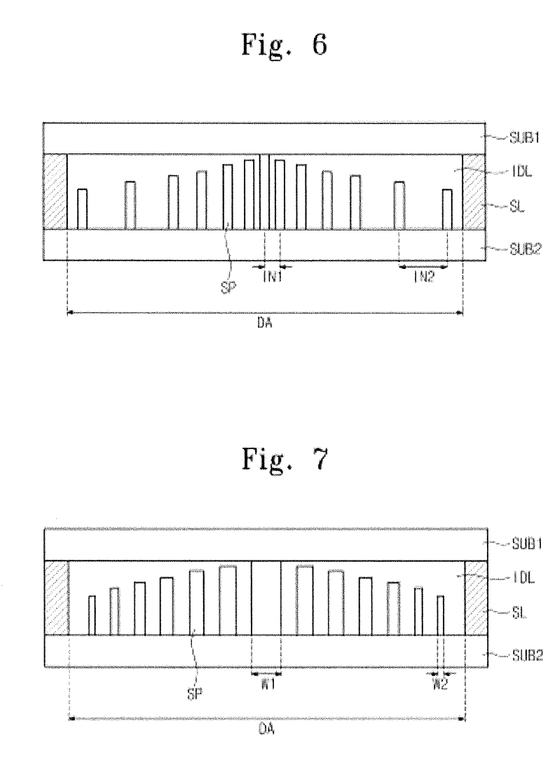

FIG. 6 is a cross-sectional view of another exemplary embodiment of a display device in accordance with the invention. If it is assumed that the display device of FIG. 1 is provided to have a flat surface, FIG. 6 is a cross-sectional view taken along line I-I′ of FIG. 2.

In the illustrated exemplary embodiment, in a direction approaching the end portion from the center portion of the second substrate SUB2, the spacers SP have sequentially a lower density (e.g., the number of spacers/unit area). That is, in the approaching the end portion from the center portion of the second substrate SUB2, the number of the spacers SP per unit area decreases. If the density of the spacers SP at the center portion is referred to as a first density and the density of the spacers SP at the end portion is referred to as a second density, the first density is greater than the second density.

An interval between adjacent spacers SP at the center portion is different from an interval between adjacent spacers SP at the end portion. The interval between adjacent spacers SP at the center portion is smaller than the interval between adjacent spacers SP at the end portion. That is, if the interval between adjacent spacers SP at the center portion is referred to as a first space IN1 and the space between adjacent spacers SP at the end portion is referred to as a second space IN2, the first space IN1 is smaller than the second space IN2.

An amount of change in the interval between adjacent spacers SP and/or an amount of change of the density of adjacent areas in which spacers SP are disposed, may be substantially uniform over an entire area of the second substrate SUB2. However, the invention is not limited thereto and the amount of change may be different depending on an area of the second substrate SUB2.

In the display device having the structure described above, the gap between the first substrate and the second substrate, that is, a cell gap is substantially uniformly maintained over an entire area of the first substrate or the second substrate. Since the number of the spacers disposed at the center portion between the first and second substrates is larger than the number of the spacers disposed at the end portion between the first and second substrates, a space between the first substrate and the second substrate is sufficiently and uniformly maintained.

FIG. 7 is a cross-sectional view of another exemplary embodiment of a display device in accordance with the invention. If it is assumed that the display device of FIG. 1 is provided to have a flat surface, FIG. 7 is a cross-sectional view taken along line I-I′ of FIG. 2.

In the illustrated exemplary embodiment, in a direction approaching the end portion from the center portion of the second substrate SUB2, top surface areas or planar areas of the spacers SP decrease to become sequentially smaller. In one exemplary embodiment, for example, if when the spacer SP has a cylindrical shape, a diameter (e.g., the planar area) of the spacers SP disposed at the center portion is referred to as a first diameter W1 and a diameter of the spacers SP disposed at the end portion is referred to as a second diameter W2, the first diameter W1 is greater than the second diameter W2. The number of spacers SP per unit area can be uniformly maintained.

In the direction of the end portion from the center portion, an amount of change of the top surface areas of the spacers SP may be substantially uniform over an entire area of the second substrate SUB2. That is, the top surface areas of the spacers SP may be sequentially reduced at a steady rate. However, the invention is not limited thereto and the amount of change may depend on an area of the second substrate SUB2.

In the display device having the structure described above, the gap between the first and second substrates, that is, a cell gap is substantially uniformly maintained over an entire area of the first substrate or the second substrate. Since the spacers having a larger planar area are disposed at the center portion between the first and second substrates, a space between the first and second substrates is sufficiently and uniformly maintained.

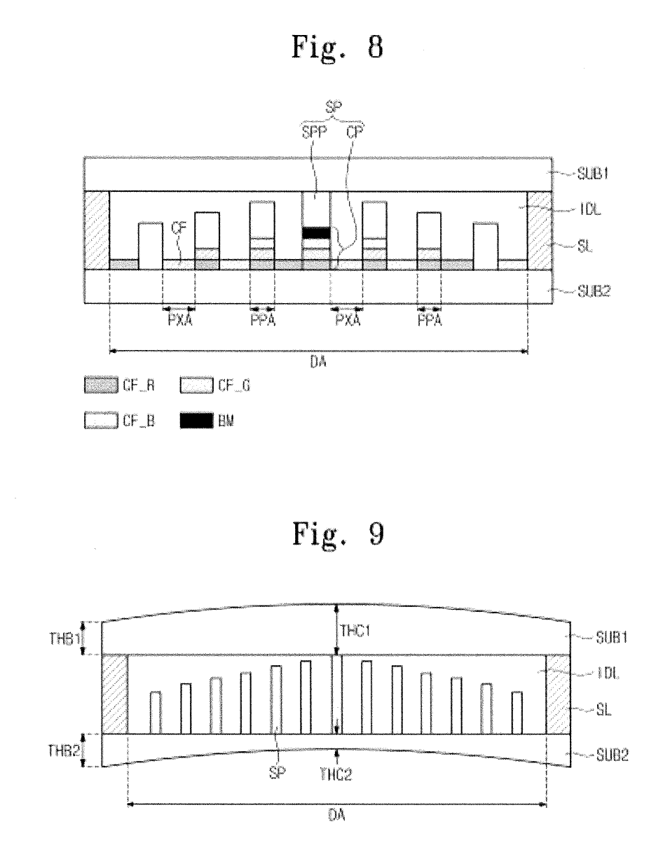

FIG. 8 is a cross-sectional view of another exemplary embodiment of a display device in accordance with the invention. If it is assumed that the display device of FIG. 1 is provided to have a flat surface, FIG. 8 is a cross-sectional view taken along line I-I′ of FIG. 2.

The display device includes a first substrate SUB1, a second substrate SUB2, an image display layer IDL, a sealant SL, spacers SP, color filters CF and a black matrix BM.

The color filters CF provide color to the image display layer IDL and are provided in a display area DA of the display device. The color filters CF may include one or more red color filter CF_R, one or more green color filter CF_G and one or more blue color filter CF_B. However, the invention is not limit thereto and the color filters CF may include color filters having different colors such as yellow color filters and/or white color filters, etc.

In the plan view, the display area DA includes a plurality of pixel areas PXA arranged in a matrix form to display an image and a peripheral area PPA disposed around each pixel area PXA. In FIG. 8, in the display area DA, areas in which spacers SP are not disposed are represented as pixel areas PXA and areas in which the spacers SP are disposed are represented as peripheral areas PPA.

The color filters CF may be provided to correspond to the pixel areas PXA in a one-to-one relationship. The black matrix BM blocks light traveling to an area excluding the pixel area PXA and The black matrix BM is provided on the peripheral area PPA of the display area DA of the display device.

The spacers SP are provided on the peripheral area PPA. Each spacer SP located at the center portion of the second substrate SUB2 includes a color portion CP including at least one of the black matrix BM and the color filters CF, and a support portion SSP disposed on the color portion CP.

The spacers SP located at the end portion of the first substrate SUB1 may include only the support portion SSP. In one exemplary embodiment, the endmost spacers SP may include only the support portion SSP, but the invention is not limited thereto.

Each color portion CP may include at least one of the red color filter CF_R, the green color filter CF_G the blue color filter CF_B and the black matrix BM. Where the color portion CP includes a plural number of the color filters CF, the color filters CF are sequentially stacked. The support portion SSPs have a same height over an entire area of the substrate SUB1 and are disposed on the color portion CP. In one exemplary embodiment, the support portion SSP is at a distal end of the spacer SP with respect to the second substrate SUB2.

Since each of the red color filter CF_R, the green color filter CF_G, the blue color filter CF_B and the black matrix BM has a predetermined cross-sectional thickness, where the color filters are stacked, total heights of the spacers SP including the color filters may be different from one another. As illustrated in FIG. 8, since the spacers SP located at the center portion of the second substrate SUB2 include the red color filter CF_R, the green color filter CF_G, the blue color filter CF_B and the black matrix BM, an overall height of the spacers at the center portion are relatively large. Since in the spacers SP located at the end portion of the second substrate SUB2, the black matrix BM, the blue color filter CF_B and/or the green color filter CF_G is omitted in a direction approaching the end portion, overall heights of the spacers at the end portion are smaller than the heights of the spacers SP at the center portion. That is, the overall heights of the spacers SP may decrease in the direction approaching the end portion.

Consequently, in the illustrated exemplary embodiment, the spacers SP have sequentially smaller height in a direction approaching the end portion from the center portion of the second substrate SUB2.

In an exemplary embodiment of a method of manufacturing the display device, the spacers SP may be formed in concurrence with the color filters CF such as through a photolithography process using a photoresist. That is, the spacers SP may be formed from a same material, at substantially a same time, and/or in substantially a same process as the color filters CF.

In one exemplary embodiment of a method of manufacturing the display device, the photolithography process is performed as follows.

A photoresist expressing one color of the color filters of the spacers, for example, a red photoresist is coated on the second substrate. The photoresist is patterned through an exposure process and a development process. By patterning the photoresist, a photoresist on a pixel area corresponding to a pixel in which a red color filter should be formed and a photoresist on spacers that include a red color filter remain, while a remainder of the photoresist is removed.

In the same manner, a green photoresist and a blue photoresist are formed.

A photoresist for a black matrix is coated on the second substrate and the photoresist is patterned through an exposure process and a development process. By patterning the photoresist, a photoresist on a peripheral area and a photoresist on the spacers that includes a black matrix remain, while a remainder of the photoresist is removed.

Herein, the color filters and the black matrix of the color portion of the spacer are formed by a photolithography process but the invention is not limited thereto. The color filters and the black matrix may be formed by any of a number of different processes such as a deposition process.

A support portion of the spacers is formed on the second substrate. A method of forming the support portion is substantially the same as the method of manufacturing spacers in accordance with one or more exemplary embodiments of the invention. In one exemplary embodiment of a method of manufacturing the display device, when a height and an area of each support portion of the spacer are the same, a slit mask or a halftone mask is not used.

A display device having the structure described above can maintain a substantially uniform cell gap between the center portion and the end portion of the substrates, and thereby provide the display device including the substrates with a high quality video or image.

FIGS. 9, 10 and 11 are cross-sectional views of display devices in accordance with other exemplary embodiments of the invention. If assuming that the display device of FIG. 1 is provided to have a flat surface, FIGS. 9, 10 and 11 are cross-sectional views taken along line I-I′ of FIG. 2. In each exemplary embodiment, the spacers illustrated in FIGS. 3, 6, 7 and 8 and combinations thereof may be applied. However, for convenience of description, it is assumed that the spacers of FIG. 3 are applied to the display devices illustrated in FIGS. 9, 10 and 11 as an illustration.

Referring to FIGS. 9, 10 and 11, a first substrate SUB1 and a second substrate SUB2 may be provided in various forms so that a space between the first substrate SUB1 and the second substrate SUB2 is maintained substantially constant according to a curve direction or the degree of curvature. In each of the first and second substrates SUB1 and SUB2, to curve a first part of the substrate to have a relatively high curvature, the first part of the corresponding substrate which is curved the most relative to other parts of the substrate may have a relatively small cross-sectional thickness compared to the cross-sectional thickness of other parts of the substrate. To stably curve a second part of the substrate to have a relatively low curvature, the second part of the corresponding substrate may have a relatively large cross-sectional thickness compared to the cross-sectional thickness of other parts of the substrate. Exemplary embodiments of a display device having various curve directions or degrees of curve while having a constant cell gap by combining at least one thickness of the first substrate SUB1 and the second substrate SUB2 with the spacers in accordance with invention is described below.

Referring to FIG. 9, from a center portion toward an end portion of the first substrate SUB1, a thickness of the first substrate SUB1 is reduced. In the first substrate SUB1, if a thickness of the center portion is referred to as a first thickness THC1 and a thickness of the end portion is referred to as a second thickness THB1, the first thickness THC1 is greater than the second thickness THB1. In the second substrate SUB2, from a center portion toward an end portion of the second substrate SUB2, a thickness of the second substrate SUB2 is increased. In the second substrate SUB2, if a thickness of the center portion is referred to as a third thickness THC2 and a thickness of the end portion is referred to as a fourth thickness THB2, the third thickness THC2 is smaller than the fourth thickness THB2.

In the illustrated exemplary embodiment, where an entire portion of the display device is convexly curved in a lower direction, although a force is applied in a center portion direction, since the center portion of the first substrate SUB1 is thick, the first substrate SUB1 is relatively less curved. With respect to the second substrate SUB2, although a force is applied in an end portion direction, since a thickness of the center portion is smaller than the thickness of the center portion of the first substrate SUB1, the second substrate SUB2 is relatively more curved. Accordingly, the degree of curvature between the first substrate SUB1 and the second substrate SUB2 can be controlled, and a phenomenon that an undesirable reduction in a cell gap is reduced or effectively prevented.

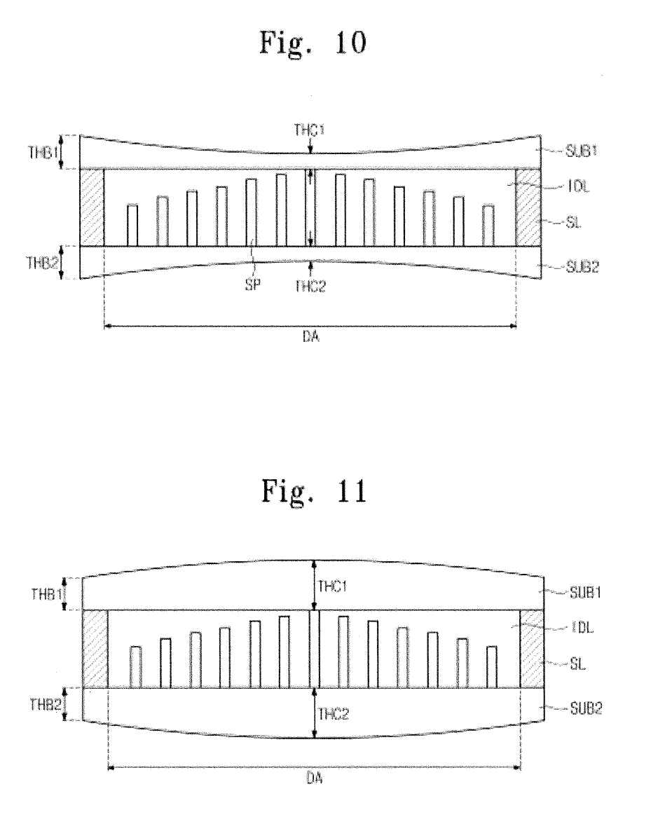

Referring to FIG. 10, a thickness of the first substrate SUB1 increases in a direction approaching an end portion from a center portion of the first substrate SUB1. In the first substrate SUB1, the first thickness THC1 is smaller than the second thickness THB1. A thickness of the second substrate SUB2 also increases in a direction approaching an end portion from a center portion of the second substrate SUB2. The third thickness THC2 is smaller than the fourth thickness THB2.

In the illustrated exemplary embodiment, where an entire portion of the display device is convexly curved in a lower direction or an upper direction, since the center portion of both the first substrate SUB1 and the second substrate SUB2 is relatively thinner than remaining portions of the respective substrate, both the first and second substrates SUB1 and SUB2 may be curved to have a relatively high curvature. Accordingly, a cell gap can be maintained substantially constant by spacers SP between the first and second substrates SUB1 and SUB2.

Referring to FIG. 11, a thickness of the first substrate SUB1 is reduced in a direction approaching an end portion from a center portion of the first substrate SUB1. In the first substrate SUB1, the first thickness THC1 is greater than the second thickness THB1. A thickness of the second substrate SUB2 also is reduced in a direction approaching an end portion from a center portion of the second substrate SUB2. The third thickness THC2 is greater than the fourth thickness THB2.

In the illustrated exemplary embodiment, where an entire portion of the display device is convexly curved in a lower direction or an upper direction, since the center portion of both the first substrate SUB1 and the second substrate SUB2 is relatively thicker than remaining portions of the respective substrate, the first and second substrates SUB1 and SUB2 may be curved to have a relatively low curvature. Accordingly, a cell gap can be maintained substantially constant by spacers SP between the first and second substrates SUB1 and SUB2.

The first substrate and/or the second substrate of FIGS. 9, 10 and 11 may be manufactured by an etching process using a mask. In an exemplary embodiment of a method of manufacturing the display device, a method of etching the first substrate and/or the second substrate is as follows.

A substrate to be etched is prepared. The substrate may include a transparent glass substrate.

A mask is disposed on the substrate to be etched. The mask has a penetration portion through which an etching solution can penetrate and a shut-off portion which prevents penetration of the etching solution. The penetration portion and the shut-off portion may be variously disposed according to a shape of the substrate. To make a form similar to the first substrate SUB1 of FIG. 10 by etching the center portion of the substrate more and etching the end portion of the substrate less, the penetration portion may be disposed more in an area of the mask corresponding to the center portion of the substrate and the shut-off portion may be disposed more in an area of the mask corresponding to the end portion of the substrate.

An etching solution is applied such as being sprayed on the substrate. The etching solution reaches a top surface of the substrate through the penetration portion of the mask to etch the underlying substrate. A part on which the penetration portion is relatively more disposed contacts the etching solution more and thereby this part of the substrate is etched more. A part on which the penetration portion is relatively less disposed contacts the etching solution less and thereby this part is etched less.

Using that method described above, a substrate having areas of different thicknesses can be manufactured.

The above-disclosed subject matter is to be considered illustrative, and not restrictive, and the appended claims are intended to cover all such modifications, enhancements, and other embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. A display device comprising:
a curved first substrate;
a second substrate facing the first substrate;
an image display layer between the first and second substrates, which displays an image; and
a plurality of spacers between the first and second substrates, which maintains a gap between the first and second substrates,
wherein heights of the plurality of spacers decrease from a center portion of the display device toward an end portion of the display device.

2. The display device of claim 1, further comprising:
color filters on the second substrate, which provide color to the image display layer; and
a black matrix between the color filters.

3. The display device of claim 2, wherein in for a portion of the plurality of spacers, each spacer comprises:
a color portion comprising at least one of the black matrix and a color filter, and
a support portion on the color portion.

4. The display device of claim 3, wherein the second substrate comprises a display area in which the image is displayed, the display area comprising:
a pixel area which displays the image, and
a peripheral area excluding the pixel area,
wherein the plurality of spacers is in the peripheral area.

5. The display device of claim 4, wherein
the color filters comprise a red color filter, a green color filter and a blue color filter.

6. The display device of claim 5, wherein the each spacer comprises more than one of the color filters which are sequentially stacked.

7. The display device of claim 1, wherein the first and second substrates are rectangular shaped and comprise a pair of long sides and a pair of short sides, and
heights of the plurality of spacers decrease from the center portion toward the end portion along one of the long sides and the short sides.

8. A method of manufacturing a curved display device, the method comprising:
providing a first substrate which is curved along a curved direction;
providing a second substrate facing the first substrate;
providing an image display layer between the first and second substrates, wherein the image display layer displays an image; and
providing a plurality of spacers between the first and second substrates, wherein the plurality of spacers maintains a gap between the first and second substrates,
wherein heights of the plurality of spacers decrease from a center portion of the display device toward an end portion of the display device, along the curved direction.

9. The method of claim 8, further comprising providing a plurality of color filters in image-displaying pixel areas of a display area of the display device,
wherein the plurality of spacers are provided in non image-displaying peripheral areas adjacent to the pixel areas of the display area of the display device.

10. The method of claim 9, wherein each spacer of the plurality of spacers comprises a support portion, and the support portions have a same cross-sectional thickness.

11. The method of claim 10, wherein a portion of the plurality of spacers comprises a color filter.
